(19) United States
(12) Patent Application Publication
(10) Pub. No.: US 2023/0295408 A1
(43) Pub. Date: Sep. 21, 2023

(54) RESIN COMPOSITION TO BE CROSS-LINKED AND FOAMED

(71) Applicant: MIZUNO CORPORATION, Osaka (JP)

(72) Inventor: Tetsuya Sasamori, Osaka (JP)

(21) Appl. No.: 18/121,794

(22) Filed: Mar. 15, 2023

(30) Foreign Application Priority Data
Mar. 15, 2022 (JP) 2022-040581

(51) Int. Cl. C08L 23/16; C08L 23/08; C08L 23/18; C08L 53/00; C08K 5/09; C08K 5/101; C08K 5/14; C08J 9/14; A43B 13/04; A43B 13/12

(52) U.S. Cl. CPC C08L 23/16; C08L 23/0853; C08L 23/18; C08L 53/00; C08K 5/09; C08K 5/101; C08K 5/14; C08J 9/149; A43B 13/04; A43B 13/125; C08L 2203/14; C08L 2205/025; C08L 2205/03; C08J 2203/20; C08J 2323/16; C08J 2353/00; C08J 2323/08

(57) ABSTRACT

A resin composition to be cross-linked and foamed includes thermoplastic resin, a cross-linking agent, and a foaming agent, further including: ethylene propylene diene monomer rubber having an ethylene content lower than 70 mass %. The ethylene propylene diene monomer rubber amounts for 5 mass % or more of a sum of the thermoplastic resin and the ethylene propylene diene monomer rubber.

### CROSS-REFERENCE TO RELATED APPLICATION

This application claims priority to Japanese Patent Application No. 2022-040581 filed on Mar. 15, 2022 .the entire disclosure of which is incorporated by reference herein.

### BACKGROUND

The present disclosure relates to a resin composition to be cross-linked and foamed for forming a cross-linked foam for use in shoe soles. e soles.

Some shoes such as sports shoes include foam intermediate portions (i.e., foam midsoles or foam insoles) to improve the comfort in walking, running or wearing the shoes and reduce fatigue, injury, or other problems.

As such a foam, for example, a cross-linked foam made from a polymer such as a styrene-based thermoplastic elastomer has been suggested. The cross-linked foam has a predetermined spin-spin relaxation time in the pulse nuclear magnetic resonance (NMR) (at 23° C.) and a predetermined complex modulus measured by dynamic viscoelasticity measurement under a frequency of 1 Hz, a strain of 0.025%, and a rate of temperature rise of 2° C./min (see, e.g., Japanese Patent No. 5719980). Japanese Patent No. 5719980 describes that such a configuration provides a cross-linked foam with a low specific gravity and a high heat resistance.

### SUMMARY

Sports shoes and the other types of shoes are required to have heat resistances because such shoes would be used not only at room temperature but also at high temperatures and are expected to be subjected to heating in a bonding process. The conventional cross-linked foam described above have such a drawback that modifications of the foam in the polymer composition, blending ratios, or the like for improving the foam in heat resistance do not provide desired physical properties such as strength and rebound resilience.

The present disclosure was made in view of the problem. It is an object of the present disclosure to provide a resin composition to be cross-linked and foamed, from which a cross-linked foam with an excellent resilience can be produced still with a strength equivalent to that of the conventional cross-linked foams.

In order to achieve the object, a resin composition to be cross-linked and foamed according to the present disclosure, including a thermoplastic resin, a cross-linking agent, and a foaming agent, the resin composition further including: ethylene propylene diene monomer rubber having an ethylene content lower than 70 mass %, the ethylene propylene diene monomer rubber amounting for 5 mass % or more of a sum of the thermoplastic resin and the ethylene propylene diene monomer rubber.

The present disclosure provides a resin composition to be cross-linked and foamed, from which a cross-linked foam having an excellent resilience can be produced still with a strength equivalent to that of the conventional cross-linked foams.

### DETAILED DESCRIPTION

A preferred embodiment of the present disclosure will be described below.

A resin composition to be cross-linked and foamed according the present disclosure includes a thermoplastic resin, ethylene propylene diene monomer rubber (hereinafter, which may be referred to as “EPDM”), a cross-linking agent, and a foaming agent. The composition according the present disclosure is for forming a cross-linked foam for shoe soles by cross-linking and foaming the composition.

### Thermoplastic Resin

Examples of the thermoplastic resin according the present disclosure include α-olefin copolymers, α-olefin block copolymers, ethylene vinyl acetate copolymers, polyamides, and polyether block amides, and the like. These may be employed solely, or two or more of them may be employed in combination.

For the sake of easily providing the cross-linked foam with a strength and a rebound resilience within appropriate ranges, it is preferable to employ, from among them, at least one selected from the group consisting of α-olefin copolymers, α-olefin block copolymers, and ethylene-vinyl acetate copolymers.

The content of the thermoplastic resin in the whole resin composition to be cross-linked and foamed may be preferably in a range of from 50 mass % to 95 mass %, or more preferably in a range of from 60 mass % to 90 mass %. If the content of the thermoplastic resin was lower than 50 mass %, the content of the components other than the thermoplastic resin would be so high that would likely lead to a higher viscosity, consequently resulting in defective foaming. If the content of the thermoplastic resin was higher than 95 mass %, resultant shortage of the foaming agent would likely cause defective foaming.

In a base composition consisting of a thermoplastic resin and ethylene propylene diene monomer rubber, it is preferable that a base composition assumingly including only the thermoplastic resin has a hardness of 86 or less, the hardness being determined by following Equation (1):

[Math 1]

Hardness of Base Composition Assumingly Including Only Thermoplastic Resin by 100%={(Hardness of First Thermoplastic Resin×Content of First Thermoplastic Resin in Base Composition)+(Hardness of Second Thermoplastic Resin×Content of Second Thermoplastic Resin in Base Composition)+. . . +(Hardness of n-th Thermoplastic Resin×Content of n-th Thermoplastic Resin in Base Composition)}/{1−(Content of Ethylene propylene diene monomer rubber in Base Composition)} (1)

With the configuration in which the hardness of the base composition assumingly including only the thermoplastic resin is 86 or less, the rubber elasticity of the cross-linked foam can be improved, thereby making it possible to provide a cross-linked foam with an excellent resilience.

Note that the term “hardness” here refers to a hardness measured using a type A durometer according to JIS K 6253.

### Ethylene Propylene Diene Monomer Rubber

Ethylene propylene diene monomer rubber according to the present disclosure has an ethylene content lower than 70 mass %. With such an ethylene content lower than 70 mass %, such a small amount of ethylene serving as a resin component lowers the crystallinity of the ethylene propylene diene monomer rubber, so that the ethylene propylene diene monomer rubber becomes amorphous, which leads to an improvement in the resilience of the resultant cross-linked foam.

The diene monomer for crosslinking employed in the ethylene propylene diene monomer rubber is not particularly limited, and examples thereof include ethylidene norbornene (ENB), dicyclopentadiene (DCPD), and 1,4-hexadiene (1,4-HD), and the like.

For improving the crosslinking ability, it is preferable that the content of the diene monomer for crosslinking with respect to the entire ethylene propylene diene monomer rubber be in a range of from 0.5 mass % to 14 mass %.

It is preferable that the ethylene propylene diene monomer rubber have a Mooney viscosity (ML1+4 at 125° C.) in a range of from 20 to 85. A Mooney viscosity of 20 or more increases the strength of the cross-linked foam, while a Mooney viscosity of 85 or less can prevent an excessive hardness of the cross-linked foam.

Note that the term “Mooney viscosity” here refers to a viscosity measured according to JIS K 6300-1 (2001).

One of the features of the resin composition to be cross-linked and foamed according the present disclosure is that the ethylene propylene diene monomer rubber amounts for 5 mass % or more of the sum of the thermoplastic resin and the ethylene propylene diene monomer rubber.

More specifically, for example, assume that the total mass of the thermoplastic resin and the ethylene propylene diene monomer rubber is 100 parts by mass (e.g., where the thermoplastic resin accounts for 90 parts by mass and the ethylene propylene diene monomer rubber account for 10 parts by mass). In this case, resin composition to be cross-linked and foamed according the present disclosure includes the ethylene propylene diene monomer rubber in such an amount that the ethylene propylene diene monomer rubber amounts for 5 mass % or more (i.e., 10 mass % in this example) of the sum of the thermoplastic resin and the ethylene propylene diene monomer rubber.

Such a configuration can improve the strength of the resultant cross-linked foam and thus can provide a resin composition to be cross-linked and foamed, from which a cross-linked foam with an excellent resilience can be produced still with a strength equivalent to that of the conventional cross-linked foams.

For maintaining the strength of the improved cross-linked foam, it is preferable that the ethylene propylene diene monomer rubber amount for 30 mass % or less of the sum of the thermoplastic resin and the ethylene propylene diene monomer rubber.

### Cross-Linking Agent

The cross-linking agent is not particularly limited and may be a cross-linking agent generally employable in a resin composition to be cross-linked and foamed, such as sulfur or an organic peroxide that promotes peroxide cross-linking. Examples of the organic peroxide include dicumyl peroxide, di-t-butyl peroxide, 2,5-dimethyl-2,5-di-(t-butylperoxy)hexane, 2,5-dimethyl-2,5-di-(t-butylperoxy)hexyne-3,1,3-bis(t-butylperoxyisopropyl)benzene, 1,1-bis(t-butylperoxy)-3,3,5-trimethylcyclohexane, n-butyl-4,4-bis(t-butylperoxy)valerate, benzoyl peroxide, p-chlorobenzoyl peroxide, 2,4-dichlorobenzoyl peroxide, t-butyl peroxybenzoate, t-butyl perbenzoate, t-butyl peroxyisopropyl carbonate, diacetyl peroxide, lauroyl peroxide, t-butyl cumyl peroxide, and the like. These may be employed solely, or two or more of them may be employed in combination.

The content of the cross-linking agent with respect to the whole resin composition to be cross-linked and foamed may be preferably in a range of from 0.05 mass % to 3.0 mass %, or more preferably in a range of from 0.1 mass % to 1.0 mass %. If the content of the cross-linking agent was lower than 0.05 mass %, this would lead to inefficient cross-linking reaction, which would cause defective foaming, resulting in a lower rebound resilience. If the content of the cross-linking agent was higher than 3.0 mass %, the cross-linking would excessively proceed, resulting in inefficient foaming.

### Foaming Agent

The foaming agent is not particularly limited, as long as the foaming agent causes thermal generation of a gas necessary for foaming the resin composition to be cross-linked and foamed. Specific examples thereof include N,N′-Dinitrosopentamethylenetetramine (DNPT), 4,4′-oxybis(benzenesulfonyl hydrazide)(OBSH), azodicarbonamide (ADCA), sodium hydrogen carbonate, sodium bicarbonate, ammonium bicarbonate, sodium carbonate, ammonium carbonate, azobis(isobutyronitrile), barium azodicarboxylate, and the like. These may be employed solely, or two or more of them may be employed in combination.

The content of the foaming agent in the whole resin composition to be cross-linked and foamed may be preferably in a range of from 1.0 mass % to 15 mass %, or more preferably in a range of from 1.5 mass % to 10 mass %. If the content of the foaming agent was lower than 1.0 mass %, this would fail stable foaming. If the content of the foaming agent was higher than 15 mass %, this would cause excessive foaming, resulting in uneven sizes of foam cells in a surficial portion or an inner portion of the resultant foam.

Optionally, the resin composition to be cross-linked and foamed according to the present disclosure may further include a cross-linking auxiliary agent, a foaming auxiliary agent, or the like, so that the cross-linked foam may be produced from such a resin composition cross-linked and foamed under predetermined conditions.

### Cross-Linking Auxiliary Agent

The crosslinking auxiliary agent is not particularly limited. Examples thereof include divinylbenzene, trimethylolpropane trimethacrylate, 1,6-hexanediol methacrylate, 1,9-nonanediol dimethacrylate, 1,10-decanediol methacrylate, triallyl trimellitate, triallyl isocyanurate, neopentyl glycol dimethacrylate, triallyl 1,2,4-benzenetricarboxylate, tricyclodecane dimethacrylate, polyethylene glycol diacrylate, and the like. These may be employed solely, or two or more of them may be employed in combination.

The content of the cross-linking auxiliary agent in the whole resin composition to be cross-linked and foamed may be preferably in a range of from 0.01 mass % to 5 mass %, or more preferably in a range of from 0.05 mass % to 1 mass %. If the content of the cross-linking auxiliary agent was lower than 0.01 mass %, this would lead to inefficient proceeding of the cross-linking, which would lower the rebound resilience. If the content of the cross-linking auxiliary agent was higher than 5 mass %, this would increase the specific gravity of the resin component, thereby making it difficult to reduce the weight of resultant products.

### Foaming Auxiliary Agent

The foaming auxiliary agent is not particularly limited. Examples thereof include urea compounds, zinc compounds such as zinc oxide, and the like. These may be employed solely, or two or more of them may be employed in combination.

The content of the foaming auxiliary agent in the whole resin composition to be cross-linked and foamed may be preferably in a range of from 0.1 mass % to 10 mass %, or more preferably in a range of from 0.5 mass % to 8.5 mass %. According to a configuration applied generally in the art, a foaming resin composition includes a foaming auxiliary agent and a foaming agent in the same amounts. Some foaming agents are such that, if the foaming auxiliary agent was included in a smaller amount than the foaming agent, the foaming agent would generate formaldehyde or the like. Thus, the amount of the foaming auxiliary agent in the composition may be adjusted as required, according to the amount of the foaming agent.

The resin composition to be cross-linked and foamed according to the present disclosure may further include any one of various kinds of additives as necessary. Examples of the additives include fatty acids, fatty acid esters, and the like.

### Fatty Acid

The fatty acids employable may be stearic acid, lauric acid, or myristic acid, and the fatty acids may be employed solely, or two or more of them may be employed in combination.

The use of such a fatty acid causes ion decomposition of the cross-linking agent, thereby hindering excessive cross-linking reaction. Accordingly, the use of such a fatty acid can provide a greater heat resistance to the cross-linked foam formed from the resin composition according to the present disclosure.

### Fatty Acid Ester

The fatty acid esters employable in the present disclosure may be polyhydric alcohol fatty acid esters (i.e., esters of a fatty acid with a polyhydric alcohol, which have structures obtainable by esterifying at least one hydroxyl group of the polyhydric alcohol) and a higher fatty acid ester (an ester of a saturated C10 to C30 fatty acids), and the fatty acids may be employed solely, or two or more of them may be employed in combination.

Examples of the polyhydric alcohol fatty acid esters include pentaerythrityl tetrastearate, which is a tetraester of a stearic acid and pentaerythritol, pentaerythrityl tripalmitate, which is a tetraester of a palmitic acid and pentaerythritol, and the like.

Examples of the higher fatty acid esters include the esters of stearic acid, lauric acid, myristic acid, and others.

Examples of the polyhydric alcohol fatty acid esters include commercially available products such as Struktol WB222 manufactured by S & S Japan Co., LTD. Example of the higher fatty acid ester include commercially available products such as Struktol WB212 manufactured by S & S Japan Co., LTD.

The use of such a fatty acid ester causes chemisorption of a peroxide, which hinders excessive cross-linking reaction. Accordingly, the use of such a fatty acid ester can provide a greater heat resistance to the cross-linked foam formed from the resin composition according to the present disclosure.

For reliably obtaining a cross-linked foam with a higher heat resistance, the sum of the contents of the fatty acid and the fatty acid ester may be preferably in a range of from 0.5 parts by mass to 4.0 parts by mass relative to 100 parts by mass of the thermoplastic resin.

In the use of the fatty acid and the fatty acid ester in combination, the content of the fatty acid may be preferably in a range of from 0.25 mass % to 1.0 mass % and the content of the fatty acid ester may be preferably in a range of 0.25 mass % to 3.0 mass %, with respect to 100 parts by mass of the thermoplastic resin.

Next, a method of producing a cross-linked foam from the resin composition to be cross-linked and foamed according to the present disclosure will be described. The method of producing a cross-linked foam according to the present disclosure includes: mixing and kneading for preparing a resin composition to be cross-linked and foamed; and foam-molding, into a desired shape, the resin composition to be cross-linked and foamed.

### Mixing and Kneading

Raw materials such as a thermoplastic resin and ethylene propylene diene monomer rubber as a base composition, a fatty acid, a fatty acid ester, a cross-linking agent, and a foaming agent are introduced in a mixing and kneading machine, and mixed and kneaded therein to produce a resin composition to be cross-linked and foamed.

The mixing and kneading machine for use may be a mixing roll, a calender roll, Banbury mixer, a kneader, or the like.

For example, a thermoplastic resin, ethylene propylene diene monomer rubber, a fatty acid, a fatty acid ester, a cross-linking auxiliary agent, a cross-linking agent, a foaming auxiliary agent, and a foaming agent are introduced in this order into a roll set at a predetermined temperature (e.g., a surface temperature in a range of from 100° C. to 120° C.), and mixed and kneaded by using the roll, and then subjected to preforming such as sheeting or pelletizing.

The mixing and kneading may be performed stepwise, using a plurality of mixing and kneading machines. For example, a thermoplastic resin, ethylene propylene diene monomer rubber, a fatty acid, a fatty acid ester, and a foaming auxiliary agent are introduced into a kneader, and mixed and kneaded by the kneader, and, thereafter, the composition thus mixed and kneaded is transferred to a roll, and a cross-linking agent and a foaming agent are introduced in the roll, and mixed and kneaded together with the composition. The resultant composition is subjected to preforming such as sheeting or pelletizing.

### Foam-Molding

After that, the resin composition obtained in the mixing and kneading is introduced in a mold and is subjected to a heat treatment to promote foaming with the foaming agent, and, thereafter to molding and releasing, thereby preparing, in a desired shape, a resin composition to be cross-linked and foamed.

While the heating temperature in the heat treatment depends on the types of the foaming agent and the foaming auxiliary agent, the heat treatment performed at a temperature (e.g., a temperature in a range of 120° C. to 200° C., preferably in a range of 140° C. to 180° C.) equal to or higher than the decomposition temperature of the foaming agent to be used. In addition, the heat treatment may heat, in a mold under pressure, the resin composition to be cross-linked and foamed.

In these ways, the cross-linked foam according to the present disclosure can be produced.

For using the cross-linked foam for shoes, the specific weight of the cross-linked foam according to the present disclosure may be preferably 0.6 g/cm³ or less, or, especially for using the cross-linked foam for shoe midsoles, may be preferably 0.4 g/cm³ or less.

### EXAMPLES

The present disclosure will now be described, referring to Examples. The present disclosure is not limited to these Examples, and various modifications and variations of these Examples can be made without departing from the scope and spirit of the present disclosure.

### Examples 1 to 15 and Comparative Examples 1 to 6

### Production of Cross-Linked Foams

The cross-linked foams according to Examples 1 to 15 and Comparative Examples 1 to 6 with the compositions shown in Tables 1 and 2 (in which numbers indicate parts by mass of each component) were produced by the following production method.

### Mixing and Kneading

The thermoplastic resin, ethylene propylene diene monomer rubber, foaming auxiliary agent 2 (zinc oxide), the fatty acid, the fatty acid ester, and the cross-linking auxiliary agent shown in Tables 1 and 2 were introduced in a kneader set at 160° C., and mixed and kneaded for 8 to 12 minutes. Next, the composition thus mixed and kneaded was introduced into a 10-inch open roll (at a temperature in a range of 100° C. to 120° C.). After that, the cross-linking agent, foaming auxiliary agent 1, and the foaming agent shown in Tables 1 and 2 were added therein, and the composition was mixed and kneaded for 10 minutes, thereby preparing a resin composition to be cross-linked and foamed.

### Foam-Molding

In a mold (with a length of 155 mm, a width 125 mm, and a height of 10 mm), 182 g of the resin composition to be cross-linked and foamed thus produced was introduced and press-molded molded under conditions of 165° C. and 20 MPa until being uniformly foamed in the inside thereof as well, thereby obtaining a primary foam. After that, the primary foam was cut into a piece with a length of 200 mm, a width 124 mm, and a height of 16 mm, and compressed to a height of 10 mm initially at 165° C., and cooled immediately after the piece was compressed to the height of 10 mm. The primary foam under the compression maintained as cool-pressed to a room temperature (23° C.), thereby obtaining a secondary foam. This secondary foam was evaluated as the cross-linked foams according to Examples 1 to 15 and Comparative Examples 1 to 6.

### Calculation of Hardness of Thermoplastic Resins

Using Equation (1) described above, the hardness of a base composition assumingly including only the thermoplastic resin by 100% was calculated out. Table 1 shows the results.

For example, in Example 1, according to Equation (1), the hardness=(Hardness of Thermoplastic Resin 1×Content of Thermoplastic Resin 1 in Base Composition)+(Hardness of Thermoplastic Resin 2×Content of Thermoplastic Resin 2 in Base Composition)+(Hardness of Thermoplastic Resin 3×Content of Thermoplastic Resin 3 in Base Composition)}/{1−(Content of EPDM in Base Composition)}={(87×0.6)+(83×0.1)+(84×0.25)}/(1−0.05)=85.8.

### Measurement of Specific Gravity

The specific gravities of the cross-linked foams thus produced were measured by “Method A” (Immersion Method) according to JIS K 7112:1999 “Methods of determining the density and relative density of non-cellular plastic.” More specifically, foam samples (with a length of 20±1 mm, a width of 15±1 mm, and a depth of 10=1 mm) were prepared. Using an electronic hydrometer (manufactured by Alfa Mirage Co., Ltd., Product Name: MDS-300), the specific gravities [g/cm³] of the respective foam samples were calculated out from following Equation (2), where measurements were performed at a measurement temperature of 23° C. Tables 1 and 2 show the results.

[Math 2]

D[g/cm³]=W₁/(W₁−W₂) (2)

where D represents the specific weight of the sample, W₁ represents the weight of the sample in air, and W₂ represents the weight of the sample immersed in water.

### Measurement of Hardness (ASKER Durometer Type C)

The hardness of the cross-linked foams thus produced was measured according to JIS K 7312. More specifically, foam samples (with a length of 199 mm, a width of 124 mm and a thickness of 10 mm) were prepared as test pieces. Using a durometer (manufactured by KOBUNSHI KEIKI CO., LTD., Product Name: ASKER-C), the C scale hardness thereof was worked out by reading an instantaneous maximum value after pressing the foam sample with a load of about 10 N (9.8 N) at a temperature of 23° C. Tables 1 and 2 show the results.

### Measurement of Split Tear

A foam sample (with a length of 10 mm, a width of 100 mm, and a thickness of 10 mm) was prepared as a test piece from the cross-linked foams thus produced. The test piece was split at the center thereof to make a 20-mm split, and layers thus split out were clamped with chucks. The test piece was measured using a universal tester (manufactured by Instron Japan Company, Ltd., Product Name: INSTRON3365), pulling the layers apart at a rate of 100 mm/min. The test piece was measured, recording reading every 10-mm split and an average of five readings was regarded as a split tear [N/cm].

A split tear of 17 N/cm or more was determined as an improvement of strength of a cross-linked foam, while a split tear lower than 17 N/cm was determined as a poor strength of a cross-linked foam. Tables 1 and 2 show the results.

### Measurement of Rebound Resilience

The rebound resiliences of the cross-linked foam thus produced were measured according to ASTM-D2632. More specifically, a foam sample (with a thickness of 10±1 mm) was prepared. Using Vertical Rebound Resilience Tester GT-7042-V manufactured by GOTECH TESTING MACHINES INC., rebound resilience [%] was measured by dropping a metal plunger on the foam sample seven times at 5-second intervals under the condition of 23° C. and reading, in the last five times of the dropping, the pointer positions[%] at the peaking-out of the rebounding of the metal plunger (i.e., the rebound heights). The average of the readings was considered as the rebound resilience [%].

A rebound resilience of 65% or more was determined as an improvement of the resilience of a cross-linked foam, while a rebound resilience lower than 65% was determined as a poor resilience of a cross-linked foam. Tables 1 and 2 show the results.

### Measurement of Compression Set

The compression sets of the cross-linked foams thus produced were measured according to ASTM-D395 by Compression Set-Test Method B. More specifically, a foam sample (with a length of 50 mm, a width of 50 mm, and a thickness of 10 mm) was prepared as a test piece. Using a constant deflection compression tester (manufactured by GOTECH TESTING MACHINES INC., Product Name: COMPRESSION & DEFORMATION TESTER GT-7049), the thickness (h₁) of the test piece was measured in such a way that, after the test piece was compressed to 50% of the initial thickness (i.e., to a thickness of 5 mm) under an environmental temperature of 50±3° C., the test piece was stood still for six hours, decompressed and stood still at 23° C. for one hour before being measured. The compression set (C) of the foam sample was worked out the thickness (h₀) of the test piece before the compression and the thickness (h₂) of a spacer, using the following equation (3). Tables 1 and 2 show the results.

[Math 3]

C[%]=[(h₀−h₁)/(h₀−h₂)]×100 (3)

### Measurement of Shrinkage

A test piece was prepared in a size of 200 mm×124 mm×10 mm. A straight line was drawn in parallel to the long side of this test piece at a distance of 10 mm from the long side, and points were marked on the straight line at a 150-mm interval. Next, this test piece was immersed in a constant temperature bath at 70° C. for two hours and then in a constant temperature bath at 23° C. for one hour. After that, the interval of the points marked on the test piece was measured to work out how many millimeters the interval shrunk from 150 mm (i.e., the amount of shrinkage). The percentage of the amount of shrinkage with respect to the initial interval was referred to as the shrinkage [%]. Tables 1 and 2 show the results.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Blending | Thermoplastic Resin 1 | 60 | 55 | 35 | 60 | 55 | 35 | 55 | 55 |
| Ratio | Thermoplastic Resin 2 | 10 | 10 | 10 | 10 | 20 | 10 | 10 | 10 |
| (parts by | Thermoplastic Resin 3 | 25 | 25 | 25 | 25 | 25 | 25 | 25 | 25 |
| mass) | Thermoplastic Resin 4 | 0 | 0 | 0 | 0 | 0 | 0 | 0 | 0 |
| | EPDM 1 | 0 | 0 | 0 | 0 | 0 | 0 | 0 | 0 |
| | EPDM 2 | 5 | 10 | 30 | 0 | 0 | 0 | 0 | 0 |
| | EPDM 3 | 0 | 0 | 0 | 5 | 10 | 30 | 0 | 0 |
| | EPDM 4 | 0 | 0 | 0 | 0 | 0 | 0 | 10 | 0 |
| | EPDM S | 0 | 0 | 0 | 0 | 0 | 0 | 0 | 10 |
| | EPDM 6 | 0 | 0 | 0 | 0 | 0 | 0 | 0 | 0 |
| | EPDM 7 | 0 | 0 | 0 | 0 | 0 | 0 | 0 | 0 |
| | EPDM 8 | 0 | 0 | 0 | 0 | 0 | 0 | 0 | 0 |
| | Fatty Acid | 0.50 | 0.50 | 0.50 | 0.50 | 0.50 | 0.50 | 0.50 | 0.50 |
| | Fatty Acid Ester | 0.50 | 0.50 | 0.50 | 0.50 | 0.50 | 0.50 | 0.50 | 0.50 |
| | Cross-linking Auxiliary | 0.10 | 0.10 | 0.10 | 0.10 | 0.10 | 0.10 | 0.10 | 0.10 |
| | Agent | | | | | | | | |
| | Cross-Linking Agent | 0.55 | 0.50 | 0.35 | 0.60 | 0.55 | 0.40 | 0.55 | 0.50 |
| | Foaming Agent | 3.40 | 3.40 | 3.40 | 3.40 | 3.40 | 3.40 | 3.40 | 3.40 |
| | Foaming Auxiliary Agent 1 | 3.40 | 3.40 | 3.40 | 3.40 | 3.40 | 3.40 | 3.40 | 3.40 |
| | Foaming Auxiliary Agent 2 | 1.00 | 1.00 | 1.00 | 1.08 | 1.00 | 1.00 | 1.00 | 1.00 |
| | Sum | 109.45 | 109.40 | 109.25 | 109.50 | 109.45 | 109.30 | 109.45 | 109.40 |
| Evaluation | Hardness of Thermoplastic | 85.8 | 85.7 | 85.4 | 85.8 | 85.7 | 85.4 | 85.7 | 85.7 |
| | Resin [−] | | | | | | | | |
| | Specific Gravity [g/cm³] | 0.14 | 0.14 | 0.15 | 0.14 | 0.14 | 0.14 | 0.15 | 0.14 |
| | Hardness (ASKER | 41 | 38 | 36 | 38 | 38 | 33 | 41 | 39 |
| | Durometer Type C) [−] | | | | | | | | |
| | Splix Tear [N/cm] | 19 | 18 | 18 | 19 | 18 | 17 | 19 | 18 |
| | Rebound Resilience [%] | 65.6 | 67.6 | 69.4 | 65.4 | 65.2 | 69.0 | 65.8 | 65.6 |
| | Compression Set [%] | 32 | 30 | 22 | 44 | 34 | 27 | 35 | 32 |
| | Shrinkage [%] | 3.5 | 3.0 | 2.6 | 3.4 | 2.7 | 2.3 | 3.5 | 3.3 |

| | | Ex. 9 | Ex. 10 | Ex. 11 | Ex. 12 | Ex. 13 | Ex. 14 | Ex. 15 |
|---|---|---|---|---|---|---|---|---|
| Blending | Thermoplastic Resin 1 | 60 | 55 | 35 | 55 | 60 | 55 | 35 |
| Ratio | Thermoplastic Resin 2 | 10 | 10 | 10 | 10 | 10 | 10 | 10 |
| (parts by | Thermoplastic Resin 3 | 25 | 25 | 25 | 25 | 25 | 25 | 25 |
| mass) | Thermoplastic Resin 4 | 0 | 0 | 0 | 0 | 0 | 0 | 0 |
| | EPDM 1 | 0 | 0 | 0 | 0 | 0 | 0 | 0 |
| | EPDM 2 | 0 | 0 | 0 | 0 | 0 | 0 | 0 |
| | EPDM 3 | 0 | 0 | 0 | 0 | 0 | 0 | 0 |
| | EPDM 4 | 0 | 0 | 0 | 0 | 0 | 0 | 0 |
| | EPDM S | 0 | 0 | 0 | 0 | 0 | 0 | 0 |
| | EPDM 6 | 5 | 10 | 30 | 0 | 0 | 0 | 0 |
| | EPDM 7 | 0 | 0 | 0 | 10 | 0 | 0 | 0 |
| | EPDM 8 | 0 | 0 | 0 | 0 | 5 | 10 | 30 |
| | Fatty Acid | 0.50 | 0.50 | 0.50 | 0.50 | 0.50 | 0.50 | 0.50 |
| | Fatty Acid Ester | 0.50 | 0.50 | 0.50 | 0.50 | 0.50 | 0.50 | 0.50 |
| | Cross-linking Auxiliary | 0.10 | 0.10 | 0.10 | 0.10 | 0.10 | 0.10 | 0.10 |
| | Agent | | | | | | | |
| | Cross-Linking Agent | 0.60 | 0.55 | 0.40 | 0.55 | 0.60 | 0.50 | 0.30 |
| | Foaming Agent | 3.40 | 3.40 | 3.40 | 3.40 | 3.40 | 3.40 | 3.40 |
| | Foaming Auxiliary Agent 1 | 3.40 | 3.40 | 3.40 | 3.40 | 3.40 | 3.40 | 3.40 |
| | Foaming Auxiliary Agent 2 | 1.00 | 1.00 | 1.00 | 1.00 | 1.00 | 1.00 | 1.00 |
| | Sum | 109.50 | 109.45 | 109.30 | 109.45 | 109.50 | 109.40 | 109.20 |
| Evaluation | Hardness of Thermoplastic | 85.8 | 85.7 | 85.4 | 85.7 | 85.8 | 85.7 | 85.4 |
| | Resin [−] | | | | | | | |
| | Specific Gravity [g/cm³] | 0.14 | 0.15 | 0.15 | 0.14 | 0.14 | 0.14 | 0.15 |
| | Hardness (ASKER | 39 | 42 | 39 | 40 | 40 | 39 | 36 |
| | Durometer Type C) [−] | | | | | | | |
| | Split Tear [N/cm] | 18 | 20 | 17 | 21 | 19 | 21 | 22 |
| | Rebound Resilience [%] | 66.2 | 66.0 | 68.6 | 65.4 | 67.2 | 66.8 | 69.6 |
| | Compression Set [%] | 37 | 40 | 24 | 35 | 32 | 29 | 20 |
| | Shrinkage [%] | 4.1 | 3.6 | 4.7 | 4.0 | 3.7 | 2.6 | 2.3 |

Abbreviation: Ex. stands for Examples.

TABLE 2

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Blending | Thermoplastic Resin 1 | 65 | 60 | 55 | 55 | 60 | 35 |
| Ratio | Thermoplastic Resin 2 | 10 | 10 | 10 | 10 | 10 | 10 |
| (parts by | Thermoplastic Resin 3 | 25 | 25 | 25 | 25 | 25 | 25 |
| mass) | Thermoplastic Resin 4 | 0 | 5 | 10 | 0 | 0 | 0 |
| | EPDM 1 | 0 | 0 | 0 | 10 | 5 | 30 |
| | EPDM 2 | 0 | 0 | 0 | 0 | 0 | 0 |
| | EFDM 3 | 0 | 0 | 0 | 0 | 0 | 0 |
| | EPDM 4 | 0 | 0 | 0 | 0 | 0 | 0 |
| | EPDM 5 | 0 | 0 | 0 | 0 | 0 | 0 |
| | EPDM 6 | 0 | 0 | 0 | 0 | 0 | 0 |
| | EPDM 7 | 0 | 0 | 0 | 0 | 0 | 0 |
| | EPDM 8 | 0 | 0 | 0 | 0 | 0 | 0 |
| | Fatty Acid | 0.50 | 0.50 | 0.50 | 0.50 | 0.50 | 0.50 |
| | Fatty Acid Ester | 0.50 | 0.50 | 0.50 | 0.50 | 0.50 | 0.50 |
| | Cross-linking Auxiliary | 0.10 | 0.10 | 0.10 | 0.10 | 0.10 | 0.10 |
| | Agent | | | | | | |
| | Cross-Linking Agent | 0.65 | 0.60 | 0.60 | 0.55 | 0.60 | 0.35 |
| | Foaming Agent | 3.40 | 3.40 | 3.40 | 3.40 | 3.40 | 3.40 |
| | Foaming Auxiliary Agent 1 | 3.40 | 3.40 | 3.40 | 3.40 | 3.40 | 3.40 |
| | Foaming Auxiliary Agent 2 | 1.00 | 1.00 | 1.00 | 1.00 | 1.00 | 1.00 |
| | Sum | 109.55 | 109.50 | 109.50 | 109.45 | 109.50 | 109.25 |
| Evaluation | Hardness of Thermoplastic | 85.9 | 84.2 | 82.6 | 85.7 | 85.7 | 85.7 |
| | Resin [−] | | | | | | |
| | Specific Gravity [g/cm³] | 0.14 | 0.14 | 0.14 | 0.14 | 0.13 | 0.14 |
| | Hardness (ASKER | 40 | 40 | 38 | 41 | 42 | 41 |
| | Durometer Type C) [−] | | | | | | |
| | Split Tear [N/cm] | 19 | 19 | 17 | 19 | 21 | 20 |
| | Rebound Resilience [%] | 64.0 | 64.0 | 64.6 | 64.4 | 62.8 | 64.8 |
| | Compression Set [%] | 37 | 36 | 38 | 31 | 34 | 27 |
| | Shrinkage [%] | 3.7 | 3.1 | 3.3 | 3.7 | 3.7 | 3.7 |

The materials used to produce the cross-linked foams are as follows.
(1) Thermoplastic Resin 1: TAFMER DE-810 (an α-olefin copolymer with a hardness of 87, an MFR (at 190° C.) of 1.2 g/10 min, a density of 0.885 g/cm³, and a melting point of 66° C., manufactured by Mitsui Chemicals, Inc.)
(2) Thermoplastic Resin 2: INFUSE 9530 (an α-olefin block copolymer with a hardness of 83, an MFR (at 190° C.) of 5.0 g/10 min, a density of 0.887 g/cm³, and a melting point of 119° C., manufactured by The Dow Chemical Company)
(3) Thermoplastic Resin 3: UE659 (an ethylene-vinyl acetate copolymer with a hardness of 84, an MFR (at 190° C.) of 2.0 g/10 min, and a density of 0.947 g/cm³, a melting point of 77° C., and a VA amount of 25%, manufactured by UST Corporation Prospector)
(4) Thermoplastic Resin 4: TUFTEC P1083 (a partially hydrogenated styrene-butadiene-butylene-styrene block copolymer with a hardness of 56, an MFR (at 190° C.) of 3.0 g/10 min, and a density of 0.89 g/cm³, manufactured by Asahi Kasei Corporation)
(5) EPDM 1: NORDEL 4770P (ethylene propylene diene monomer rubber with a Mooney viscosity (at 125° C.) of 70, an ethylene content of 70%, and an ENB content of 4.9%, manufactured by The Dow Chemical Company)
(6) EPDM 2: NORDEL 5565 (ethylene propylene diene monomer rubber with a Mooney viscosity (at 125° C.) of 65, an ethylene content of 50%, and an ENB content of 7.5%, manufactured by The Dow Chemical Company)
(7) EPDM 3: NORDEL 4520 (ethylene propylene diene monomer rubber with a Mooney viscosity (at 125° C.) of 20, an ethylene content of 50%, and an ENB content of 4.9%, manufactured by The Dow Chemical Company)
(8) EPDM 4: NORDEL 4570 (ethylene propylene diene monomer rubber with a Mooney viscosity (at 125° C.) of 70, an ethylene content of 50%, and an ENB content of 4.9%, manufactured by The Dow Chemical Company)
(9) EPDM 5: NORDEL 6565XFC (ethylene propylene diene monomer rubber with a Mooney viscosity (at 125° C.) of 65, an ethylene content of 55%, and an ENB content of 8.5%, manufactured by The Dow Chemical Company)
(10) EPDM 6: NORDEL 4785M (ethylene propylene diene monomer rubber with a Mooney viscosity (at 125° C.) of 85, an ethylene content of 68%, and an ENB content of 4.9%, manufactured by The Dow Chemical Company)
(11) EPDM 7: ESPRENE E522 (ethylene propylene diene monomer rubber with a Mooney viscosity (at 125° C.) of 85, an ethylene content of 55%, and an ENB content of 4.0% manufactured by Sumitomo Chemical Co., Ltd.)
(12) EPDM 8: Keltan 6950C (ethylene propylene diene monomer rubber with a Mooney viscosity (at 125° C.) of 65, an ethylene content of 44%, and an ENB content of 9.0%, manufactured by ARLANXEO)
(13) Fatty Acid: Stearic Acid Camellia (a stearic acid manufactured by NOF CORPORATION)
(14) Fatty Acid Ester: Struktol-WB222 (a polyhydric alcohol fatty acid ester manufactured by S & S Japan Co., LTD.)
(15) Cross-Linking Auxiliary Agent: TAC/GR70 (triallyl cyanurate manufactured by Keltlitz-Chemie GmbH & Co. KG)
(16) Cross-Linking Agent: PERCUMYLD (dicumyl peroxide manufactured bye NOF CORPORATION)
(17) Foaming Agent: Cellular D (N,N′-Dinitrosopentamethylenetetramine manufactured by EIWA CHEMICAL IND. CO., LTD.)
(18) Foaming Auxiliary Agent 1: Cellpaste 101 (urea manufactured by EIWA CHEMICAL IND. CO., LTD.)
(19) Foaming Auxiliary Agent 2: Active Zinc Oxide AZO) (a zinc oxide manufactured by SEIDO CHEMICAL INDUSTRY CO., LTD.)

Table 1 shows that the resin compositions to be cross-linked and foamed in Examples 1 to 15, configured with such an ethylene propylene diene monomer rubber having an ethylene content lower than 70 mass %, thereby having the ethylene propylene diene monomer rubber contents of 5 mass % or more of the sum of the thermoplastic resin and the ethylene propylene diene monomer rubber, can provide cross-linked foams improved in resilience but still maintaining strengths equivalent to those of the resin compositions to be cross-linked and foamed in Comparative Examples 1 to 3 including no ethylene propylene diene monomer rubber.

On the other hand, it is found that the cross-linked foams in Comparative Examples 1 to 3 configured without such an ethylene propylene diene monomer rubber having an ethylene content lower than 70 mass % exhibit poor resilience.

It is also found that the cross-linked foams in Comparative Examples 4 to 6 configured with such an ethylene propylene diene monomer rubber having an ethylene content of 70 mass % exhibit thus poor resilience.

### INDUSTRIAL APPLICABILITY

As described above, the present disclosure is particularly usefully applicable to a resin composition to be cross-linked and foamed, from which a cross-linked foam used for shoe soles is produced.

What is claimed is:

1. A resin composition to be cross-linked and foamed, comprising a thermoplastic resin, a cross-linking agent, and a foaming agent, the resin composition further comprising:
ethylene propylene diene monomer rubber having an ethylene content lower than 70 mass %, the ethylene propylene diene monomer rubber amounting for 5 mass % or more of a sum of the thermoplastic resin and the ethylene propylene diene monomer rubber.

2. The resin composition of claim 1, wherein a base composition consisting of the thermoplastic resin and the ethylene propylene diene monomer rubber is such that a base composition assumingly including only the thermoplastic resin has a hardness of 86 or less, the hardness being determined by following Equation (1):
[Math 1]
Hardness of Base Composition Assumingly Including Only Thermoplastic Resin by 100%={(Hardness of First Thermoplastic Resin×Content of First Thermoplastic Resin in Base Composition)+(Hardness of Second Thermoplastic Resin×Content of Second Thermoplastic Resin in Base Composition)+. . . +(Hardness of n-th Thermoplastic Resin×Content of n-th Thermoplastic Resin in Base Composition)}/{1−(Content of Ethylene propylene diene monomer rubber in Base Composition)} (1).

3. The resin composition of claim 1, wherein the thermoplastic resin is made of at least one selected from the group consisting of α-olefin copolymers, α-olefin block copolymers, and ethylene-vinyl acetate copolymers.

4. The resin composition of claim 1, wherein the ethylene propylene diene monomer rubber amounts for 30 mass % or less of the sum of the thermoplastic resin and the ethylene propylene diene monomer rubber.

5. The resin composition of claim 1, further comprising: a fatty acid; and a fatty acid ester.

6. A cross-linked foam formable from the resin composition of claim 1.

7. The cross-linked foam of claim 6 having a specific gravity of 0.6 g/cm³ or less.

18. The cross-linked foam of claim 6 being for use in a shoe midsole.
